(19) United States
(12) Patent Application Publication
(10) Pub. No.: US 2022/0357527 A1
(43) Pub. Date: Nov. 10, 2022

(54) MULTICORE FIBER AND FANOUT ASSEMBLY

(71) Applicant: OFS Fitel, LLC, NORCROSS, GA (US)

(72) Inventors: Lalitkumar Bansal, Belle Mead, NJ (US); David J DiGiovanni, Mountain Lakes, NJ (US); William R Holland, Upper Black Eddy, PA (US)

(73) Assignee: OFS Fitel, LLC, Norcross, GA (US)

(21) Appl. No.: 17/765,091

(22) PCT Filed: Oct. 2, 2020
(86) PCT No.: PCT/US20/54163

§ 371 Date: Mar. 30, 2022

Related U.S. Application Data
(60) Provisional application No. 62/930,838, filed on Nov. 5, 2019.
(60) Provisional application No. 62/909,422, filed on Oct. 2, 2019.

(51) Int. Cl. G02B 6/42

(52) U.S. Cl. CPC G02B 6/421; G02B 6/4249; G02B 6/4285

(57) ABSTRACT

In accordance with a plurality of embodiments of the present invention, exemplary systems and articles of manufactures are described herein that are configured to propagate a MM signal from a light source, such as an optical fiber assembly for propagating a multimode (MM) signal from a light source, the optical fiber assembly comprising a multicore fiber (MCF) having a fiber numerical aperture (NA) value, a first core diameter and a first outer diameter (OD), and a combiner including a taper fiber bundle (TFB) portion in communication with the MCF, and at least one pigtail portion in communication with the light source, wherein the combiner propagates the MM signal from the light source, the MM signal having a signal NA value that is less than the fiber NA value such that the MM signal underfills the at least one pigtail portion.

### CROSS-REFERENCE TO RELATED APPLICATIONS

This application claims the benefit of U.S. Provisional Application No. 62/909,422, filed Oct. 2, 2019, and U.S. Provisional Application No. 62/930,838, filed Nov. 5, 2019, and both are herein incorporated by reference.

### TECHNICAL FIELD

Described herein are systems, methods, and articles of manufacture for propagating a multimode (MM) signal from a light source, more particularly, to a multicore fiber (MCF) span and an input/output (I/O) combiner (fan-in and/or fanout) assembly for propagating MM signal from a light source, such as a vertical-cavity surface-emitting laser (VCSEL) transmitter.

### BACKGROUND OF THE INVENTION

Fiber lasers are often used in high-power optical applications. In these applications, a tapered fiber bundle (TFB) optical coupler is often used to couple multiple light inputs from various light sources into a single optical output port. More specifically, TFBs are typically used to combine the output power of a plurality of lasers into a multimode optical fiber for the purpose of pumping fiber lasers and amplifiers in these high-power optical applications.

While most optical fibers have a single fiber core, which is usually located on the fiber axis, there are also specialty fibers containing multiple cores. Such fibers, called multicore fibers (MCFs), have the potential of significantly increasing the communications signal transmission capacity of current optical fiber systems by allowing a plurality of optical signals to be carried in parallel by a single fiber. MCFs have been developed that have a diameter that is equal to, or close to, that of a single-core fiber. However, since the core diameter of multimode fiber may be large (e.g., 50 um) and the outer glass diameter of optical fiber is limited by reliability in bending (e.g., <200um), it is preferable for the core diameters in an MCF to be smaller than the core diameter in commercial single-core multimode fiber.

### SUMMARY OF THE INVENTION

The present invention addresses the needs in the art and is directed to propagating a MM signal from a light source, such as a VCSEL transmitter, utilizing an MCF and a combiner (or “fanout”) assembly. According to one embodiment described herein, an NA of the cores in a multicore fiber may be greater than that of a launch fiber of the combiner. A launch fiber may be defined as a fiber which is connected or “mated” with the TFB pigtail. Accordingly, an exemplary launch fiber may mate to, and under-fill, the TFB pigtail's core-NA.

Alternatively, the NA of the cores in an MCF may be approximately equal to that of cores in a combiner launch fiber. The exemplary embodiments described herein may balance the fiber NAs and tapering factors to control where the brightness losses occur, thereby allowing for stray light to be stripped in a way to minimize cross-talk.

In accordance with a plurality of embodiments of the present invention, exemplary systems and articles of manufactures are described herein that are configured to propagate a MM signal from a light source, such as an optical fiber assembly for propagating a multimode (MM) signal from a light source, the optical fiber assembly comprising a multicore fiber (MCF) having a fiber numerical aperture (NA) value, a first core diameter and a first outer diameter (OD), and a combiner including a taper fiber bundle (TFB) portion in communication with the MCF, and at least one pigtail portion in communication with the light source, wherein the combiner propagates the MM signal from the light source, the MM signal having a signal NA value that is less than the fiber NA value such that the MM signal underfills the at least one pigtail portion.

Additional embodiments described herein relate to an optical fiber assembly for propagating an MM signal from a light source, the optical fiber assembly comprising an MCF having a fiber NA value, a first core diameter and a first OD, a combiner including a TFB portion in communication with the MCF, and at least one pigtail portion in communication with the light source, the at least one pigtail portion having a pigtail NA value and a pigtail core diameter, and a ribbon array in communication with the at least one pigtail portion, the ribbon array having a ribbon array NA value and a ribbon array core diameter, wherein at least one of the ribbon array NA value and the ribbon core diameter is mismatched from the pigtail NA value and the pigtail core diameter, respectively.

Further embodiments described herein relate to an optical fiber assembly for propagating an MM signal from a light source, the optical fiber assembly comprising an MCF having a fiber NA value, a first core diameter and a first OD, a combiner including a TFB portion in communication with the MCF, and at least one pigtail portion in communication with the light source, the at least one pigtail portion having a pigtail NA value and a pigtail core diameter, a transformer in communication with the at least one pigtail portion, and a launch fiber in communication with the light source and the transformer, the launch fiber having a launch fiber NA value and a launch fiber core diameter, wherein at least one of the launch fiber NA value and the launch fiber core diameter is mismatched from the pigtail NA value and the pigtail core diameter, respectively.

Other and further embodiments and aspects of the present invention will become apparent during the course of the following discussion and by reference to the accompanying drawings.

### BRIEF DESCRIPTION OF THE DRAWINGS

Referring now to the drawings:

FIG. 1 illustrates an exemplary system 100 of a multicore fiber and fanout assembly in accordance with one embodiment of the present invention;

FIG. 2 illustrates an exemplary system 200 of a multicore fiber and fanout assembly in accordance with one embodiment of the present invention;

FIG. 3 illustrates an exemplary system 300 of a multicore fiber and fanout assembly in accordance with one embodiment of the present invention;

FIG. 4 illustrates an exemplary system 400 of a multicore fiber and fanout assembly in accordance with one embodiment of the present invention;

FIG. 5 illustrates an exemplary system 500 of a multicore fiber and fanout assembly in accordance with one embodiment of the present invention;

FIG. 6 illustrates an exemplary system 600 of a multicore fiber and fanout assembly in accordance with one embodiment of the present invention;

FIG. 7 illustrates an exemplary system 700 of a multicore fiber and fanout assembly in accordance with one embodiment of the present invention;

FIG. 8 illustrates an exemplary system 800 of a multicore fiber and fanout assembly, wherein similar options may be used for coupling both a fan-in and a fanout in accordance with one embodiment of the present invention; and

FIG. 9 illustrates an exemplary graph 900 correlating cross-talk levels and measured channel loss according to exemplary embodiments described herein.

### DETAILED DESCRIPTION

Glossary of Terms according to one or more exemplary embodiments described herein:

MCF: multicore fiber

MM: multimode

VCSEL: a vertical-cavity surface-emitting laser

TFB: tapered fiber bundle

Taper ratio: the factor in which the TFB tapers from the MCF to a pigtail

NA value: numerical aperture value

Fiber NA value: NA of one of the cores in the MCF

Signal NA value: NA of the light in the MCF

Pigtail NA value: NA of the core of a TFB pigtail

TFB NA value: the product of the pigtail NA value times the taper ratio of the TFB

Ribbon NA value: NA of the cores of a ribbon fiber array

Launch NA value: NA of the cores of a launch fiber

The present invention relates to MCFs and fanout assemblies for propagating a MM signal from a light source, such as VCSEL transmitters, or simply “VCSELs.” As noted above, the core diameters in an MCF are preferably smaller than those in commercial single-core multimode fiber. The core NA within the MCF would need to be higher than in a larger diameter core in order to preserve brightness, wherein brightness may be understood as the product of diameter and NA. In many TFB assemblies, the core diameter may taper down from the input pigtail to the exit, thereby increasing in NA in an adiabatic taper.

One skilled in the art would understand that VCSELs may be described as semiconductor lasers, and more specifically, laser diodes with a monolithic laser resonator, wherein the emitted light leaves the transmitter in a direction perpendicular to a top surface, such as a chip surface. This is contrary to conventional edge-emitting semiconductor lasers that emit from surfaces formed by cleaving the individual chip out of a wafer. VCSELs typically have a high beam quality only for fairly small mode areas (e.g., on the order of a few microns in diameters) and are thus limited in terms of output power.

For larger mode areas, the excitation of higher-order transverse modes can not be avoided. This is a consequence of the extremely small resonator length of only a few microns. Due to the short resonator round-trip time, VCSELs can be modulated with frequencies well in the gigahertz (GHz) range. Accordingly, VCSELs may be useful as transmitters for optical fiber communications and for free-space optical communications. For short-range communications, 850 nm VCSELs are used in combination with MM fibers, wherein a data rate of 10 Gbit/s can be reached over a distance of a few hundred meters.

According to one embodiment of the present invention, there may be a plurality of VCSELs (e.g., eight VCSELs), each having an NA<0.28 and a 9um mode field diameter (MFD). An exemplary MM VCSEL may contain an aperture at a small distance above an active layer. The MFD of this exemplary MM VCSEL may be described as a diameter of the aperture or window above the active layer (e.g., about 10 um). The divergence is generated from the transverse modes supported between the top and bottom reflectors. Each of the plurality of VCSELs may also be optionally coupled into fibers with a 50 um, 0.2 NA cores, with the multiple fibers assembled into a ribbonized fiber array. This embodiment may further include a fanout component that connects to the plurality of VCSELs on one end and splices to a MM MCF (e.g., eight-core fiber) on the other end. As will be described in greater detail below, the fanout component may optionally be accomplished through a ribbonized MM fiber array, or “fiber ribbon,” connection between the light source and a pigtail portion. The exemplary fiber ribbon may feature any configuration, such as, but not limited to, a circular or “rollable-ribbon” configuration, a linear ribbon configuration, etc. Furthermore, an exemplary fiber ribbon array may be terminated in a multifiber connector, a multifiber push-on connector, an expanded beam multifiber connector, a lensed multifiber interconnect, etc.

Due to the constraints on the outer OD of the MCF fiber, there may be a mismatch in brightness (e.g., roughly equal to the product of core diameter and NA) between the input and output of the fanout. This mismatch may cause attenuation of the optical signal as light is coupled out of the cores of the MCF as stray light. The stray light from one core may couple into the other cores, resulting in signal cross-talk that can be highly detrimental to link performance. Thus, designs are needed to manage the modal content of the signal from a transmitter (e.g., VCSEL) that is launched into MCF input while minimizing the amount of stray light captured by the cores. Similarly, the MCF output may be coupled into the output fanout, which can be another source that introduces unwanted cross-talk.

Described herein are several exemplary embodiments of an MCF and combiner or fanout array for connecting to a light source (e.g., a VCSEL) having one or more dissimilar properties, such as but not limited to an NA, an OD, a core diameter, etc. The exemplary combiner array may include a launch fiber, a taper fiber bundle (TFB) portion, and a TFB pigtail portion, wherein the TFB is connected to the exemplary MCF. It is noted that this connection may be achieved via either a mechanical connector or a fusion splice. In addition, any of the spliced or mechanical connections may feature mode strippers to reduce cross-talk between each of the cores. In some situations, a similar arrangement of a combiner or fanout may be required to couple light out from the MCF.

It is noted that while the embodiments described herein discuss stray light and cross-talk resulting from a loss and/or mismatch of brightness mechanism produced by the input taper, one skilled in the art would understand that the same principles may be applied to stray light and cross-talk occurring at an output taper. In other words, the losses associated with a launch fiber, a TFB pigtail, a down-taper, and splice regions found on the input side may occur on the output side. Accordingly, cross-talk may be improved by adding a light stripper (e.g., a high-index coating, a light stripping gel, etc.) to the output or up-taper. This may be attributed to forward scattering or evanescent coupling between expanding cores. Thus, light stripping may be performed at the input taper, the output taper, or both.

As noted above, the connection between the TFB and the light source may include a ribbon array fused to the pigtail portion. If an output is required, the launch fiber may function as an output fiber, and the configuration operates in a reverse manner to connect into multiple optical receivers (e.g., instead of light sources). Similar to the launch fibers, this output can utilize the ribbon array technology mentioned above. An output fiber may be analogous to the launch fiber with light traveling in the opposite direction (e.g., carrying light from the MCF to receivers instead of sources). In other words, half of the cores in the MCF may carry light in one direction, and the other half may carry light in the opposite direction. Thus, the fibers from the TFB may be considered to be half launch (or input) fibers and half output fibers.

In order to preserve brightness, which is generally equivalent to the product of diameter and NA, the NA of the cores in MCF would need to be higher than that in a core with a larger diameter. Furthermore, in many TFB s, the core diameter tapers down from the input pigtail to the exit, necessarily increasing in NA in an adiabatic taper. In many cases (e.g., to reduce cross-talk), it is desirable for the TFB to be essentially loss-less, so with preserved brightness, the core in an input pigtail may contain lower NA light (e.g., underfilled) within a larger core to facilitate tapering to a fiber with smaller core diameter that may contain larger NA light (e.g., fully-filled).

Since the core-clad index difference does not change along the taper, it would be preferable for an input pigtail fiber to have a higher NA than the light launched into it. In other words, the input pigtail fiber should be underfilled. This may be accomplished by connecting the pigtail to a launch fiber that has a similar core diameter but a lower NA. An exemplary launch fiber coupled to a transmitter (e.g., a VCSEL) may be an OM3 or OM4 type fiber, which has 50 um core diameter and NA and under-fills the OM3/4 type fiber. In this case, it is desirable to reduce the NA of the light by either restricting the NA of light launched from the source or by mode filtering in or after the OM3 or OM4 fiber. This conditioning prevents the input pigtail from guiding higher NA light which would be stripped in the taper and potentially causing cross-talk in the MCF.

One benefit of this design of the TFB and MCF is that it facilitates the coupling of the input pigtails directly to the VCSELS without the need for a launch fiber, such as OM3 fiber. In this case, the coupling optics should underfill the input pigtail to preserve brightness through the TFB while lowering the loss.

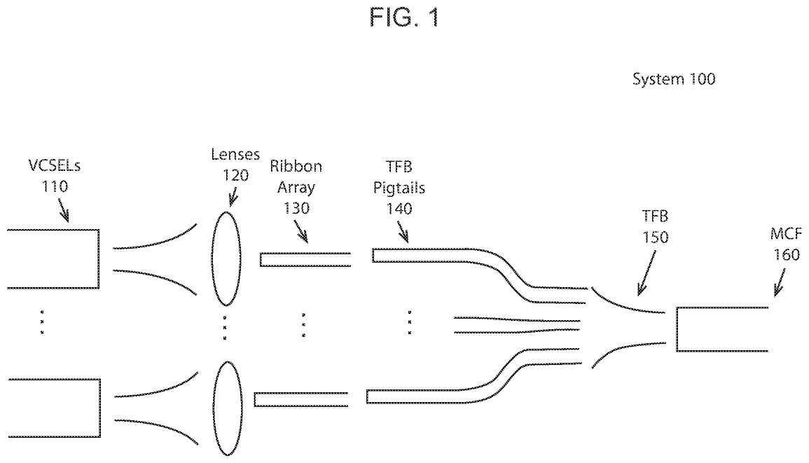

FIGS. 1-6 depict a selection of varying arrangement options for a multicore fiber and fanout assembly according to the exemplary embodiments. While each of the arrangements described in the figures below features a VCSEL having an NA<0.28 and an MFD of 9 um, it is understood that such a light source is merely for illustrative purposes, and any variations to the lights source type and/or parameters may also be utilized. It is noted that while the exemplary embodiments described herein discuss a VCSEL having an NA value of less than 0.28, alternative NA values may be used. For instance, exemplary MM VCSELs may have an NA value within a range of 0.2 to 0.3 NA. Furthermore, it is noted that exemplary VCSELs may alternatively be few-mode (FM) VCSELs or single-mode (SM) VCSELs.

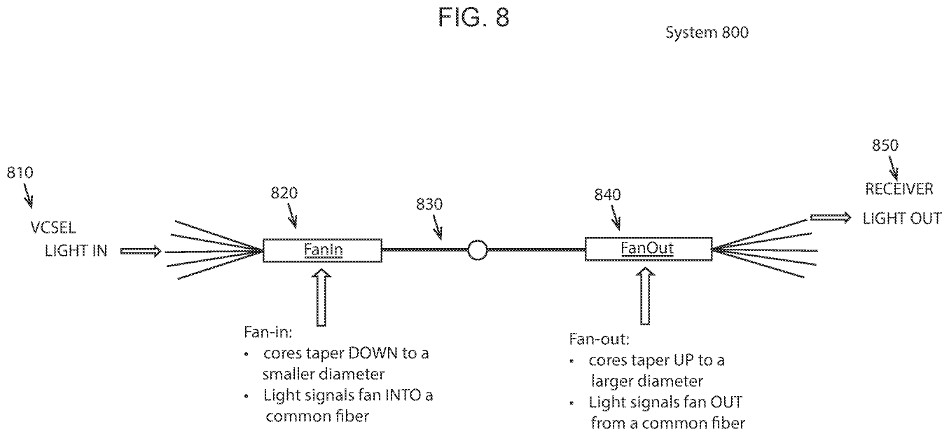

It is noted that while the various embodiments described below relate to the input side of a multicore fiber transmission assembly (e.g., the launch, TFB pigtail, down-taper, or splice regions found on the input side), additional embodiments may be directed to the output arrangements on the output side. According to these arrangements, light stripping may be performed on the output side (e.g., through the use of a high-index coating/gel or other light stripping means) for improved cross-talk (see FIG. 8 below). Furthermore, similar options to those described below could be utilized for the purpose of coupling from an MCF and into optical receivers.

FIG. 1 illustrates an exemplary system 100 of a multicore fiber and fanout assembly in accordance with one embodiment of the present invention. The system 100 includes transmitters 110, such as exemplary VCSELs having NA<0.28 and MFD of 9um. The transmitters 110 transmit through lenses 120 and are connected to an MM MCF 160 with cores having an NA of 0.20 and an MFD of 26 um. According to the embodiment of system 100, the transmitters 110 transmit via a ribbon array 130 [the ribbon has multiple fibers, but only one is shown] with fibers having NA of 0.20 and MFD of 50 um. This ribbon array may be fused to TFB pigtails 140 having NA of 0.20 and MFD of 65 um. Furthermore, the TFB pigtails 140 may be in communication with a TFB 150 having an NA>0.20 and an MFD of 26 um at its output. While FIG. 1 only shows a single fiber of the ribbon array 130, those skilled in the art would understand that the exemplary ribbon array 130 includes multiple fibers. Thus, there may be multiple emitting facets coupling into multiple cores.

It is noted that regarding MM MCF 160, and throughout various embodiments described herein, the aforementioned MFD may refer to a core diameter of a core within the MCF 160. In other words, the MFD value of a core in the MCF 160 may serve as an upper limit of MFD in the MM MCF 160. It is further noted that in the exemplary system 100 and all of the other embodiments of an exemplary system described herein, the various NA values may refer to the signal NA (e.g., NA of light produced at the output of the TFB, NA of the light launched into the pigtail fiber), the fiber NA at various components of an exemplary system (e.g., the TFB, the pigtail fiber, the launch fiber, the ribbon array, etc.)

Table 1 includes various data related to the exemplary MCF and fanout assembly.

| | MCF Core | | TFB Input | | | | | 50 um/0.20 |
|---|---|---|---|---|---|---|---|---|
| | dia | NA | dia | NA | OD | Taper Ratio | Clad/Core | Loss (dB) |
| varying MCF NA | 26 | 0.20 | 83 | 0.06 | 125 | 3.21 | 1.5 | 10 |
| | 26 | 0.30 | 83 | 0.09 | 125 | 3.21 | 1.5 | 7 |
| varying launch | 26 | 0.20 | 67 | 0.08 | 100 | 2.56 | 1.5 | 8 |
| fiber diameter | 26 | 0.20 | 53 | 0.10 | 80 | 2.05 | 1.5 | 6 |
| | 26 | 0.30 | 50 | 0.16 | 75 | 1.92 | 1.5 | 2 |
| varying launch | 26 | 0.38 | 50 | 0.2 | 75 | 1.92 | 1.5 | 0 |
| fiber NA | 26 | 0.29 | 50 | 0.15 | 75 | 1.92 | 1.5 | 2 |
| | 26 | 0.21 | 50 | 0.11 | 75 | 1.92 | 1.5 | 5 |
| Vary MCF | 20 | 0.20 | 83 | 0.05 | 125 | 4.17 | 1.5 | 12 |
| core dia | 20 | 0.20 | 67 | 0.06 | 100 | 3.33 | 1.5 | 10 |
| | 20 | 0.20 | 53 | 0.08 | 80 | 2.67 | 1.5 | 9 |
| | 20 | 0.30 | 83 | 0.07 | 125 | 4.17 | 1.5 | 9 |
| | 20 | 0.30 | 67 | 0.09 | 100 | 3.33 | 1.5 | 7 |
| | 20 | 0.30 | 53 | 0.11 | 80 | 2.67 | 1.5 | 5 |

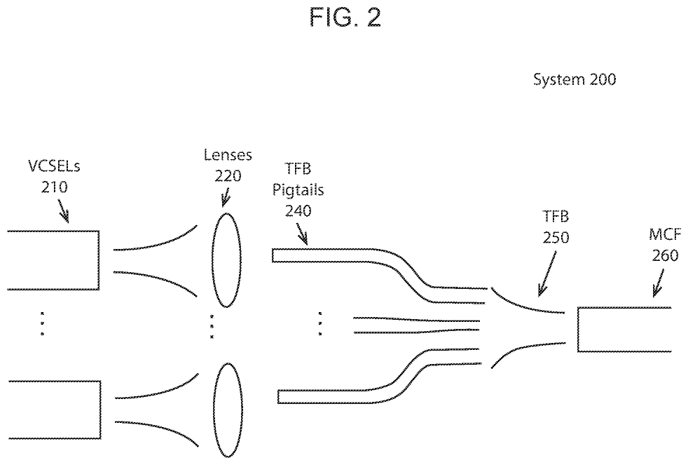

FIG. 2 illustrates an exemplary system 200 of a multicore fiber and fanout assembly in accordance with a further embodiment of the present invention. Similar to the system 100, the system 200 includes transmitters 210, such as exemplary VCSELs having NA<0.28 and MFD of 9 um. The transmitter 210 transmits through lenses 220 and is connected to an MCF 260 with cores having an NA of 0.20 and an MFD of 26 um. According to the embodiment of system 200, the transmitter 210 transmits via TFB pigtails 240, having an NA of 0.20 and an MFD of 65 um. Furthermore, the TFB pigtails 240 may be in communication with of a TFB 250 having an NA>0.20 and an MFD of 26 um at its output. Thus, in contrast to the system 100, the system 200 does not utilize a ribbon array between the lens 220 and the TFB pigtails 240.

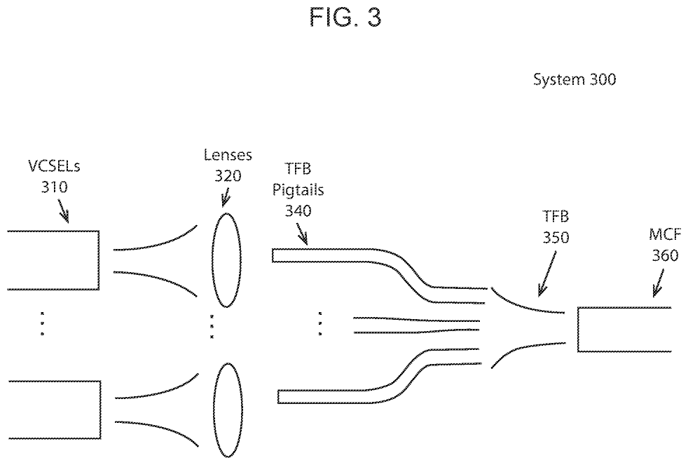

FIG. 3 illustrates an exemplary system 300 of a multicore fiber and fanout assembly in accordance with a further embodiment of the present invention. Similar to the system 200, the system 300 includes transmitters 310, such as exemplary VCSELs having NA<0.28 and MFD of 9 um. The transmitters 310 transmit through lenses 320 and are connected to an MCF 360 with cores having an NA of 0.3 and an MFD of 15 um. It is noted that the MCF 360 of the system 300 has different characteristics from the MCF 260 of the system 200. According to the embodiment of system 300, the transmitters 310 transmit via TFB pigtails 340 having an NA of 0.15 and an MFD of 37 um. Furthermore, the TFB pigtails 340 may be in communication with a TFB 350 having an NA>0.15 and an MFD of 15 um at its output. Thus, the system 300 utilizes a TFB and corresponding pigtails having a smaller NA and a smaller MFD than those used in the system 200.

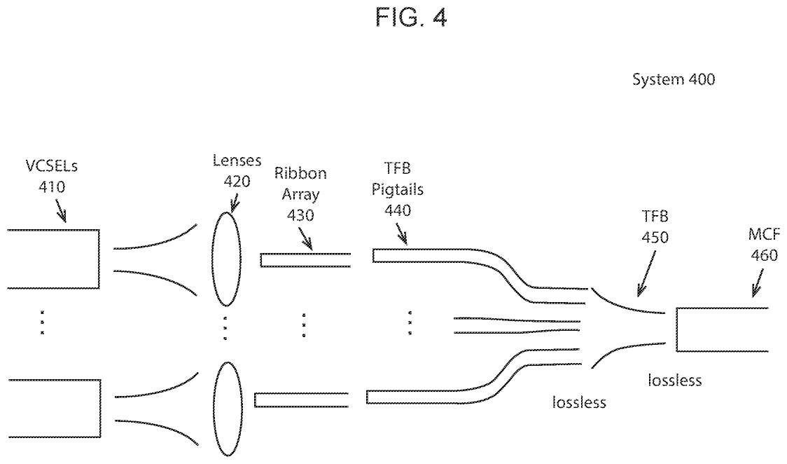

FIG. 4 illustrates an exemplary system 400 of a multicore fiber and fanout assembly in accordance with a further embodiment of the present invention. Similar to the system 100, the system 400 includes transmitters 410, such as exemplary VCSELs having NA<0.28 and MFD of 9 um. The transmitters 410 transmit through lenses 420 and are connected to an MCF 460 with cores having an NA of 0.30 and an MFD of 26 um. It is noted that the NA of the cores in the MCF 460 is larger than that of system 100. According to the embodiment of system 400, the transmitters 410 transmit via a ribbon array 430, comprising fibers having NA of 0.20 and MFD of 50 um. This ribbon array may be fused to a mismatched TFB pigtails 440 having NA of 0.16, MFD of 50 um, and OD of 75 um. Finally, the TFB pigtails 440 may be in communication with a TFB 450 having an NA>0.30 and an MFD of 26 um at its output. It is noted that the mismatched OD between the ribbon array 430 and the TFB pigtails 440 may account for a measure of splice loss, such as 2 dB of splice loss Likewise, the splice between the TFB 450 and the MCF 460 may also be an essentially lossless splice. The lossless splice will be described in great detail below.

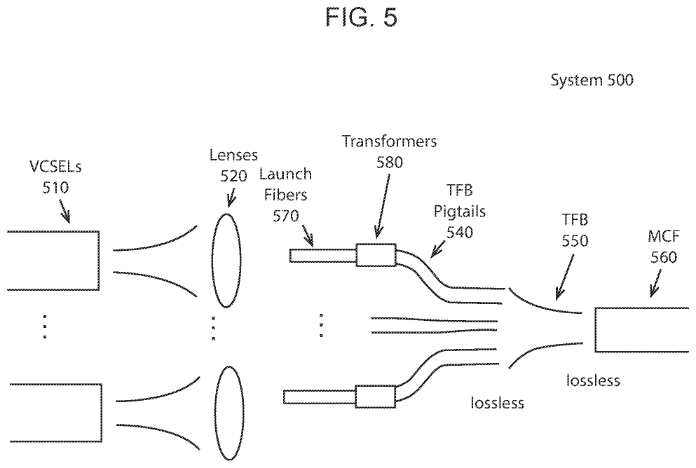

FIG. 5 illustrates an exemplary system 500 of a multicore fiber and fanout assembly in accordance with a further embodiment of the present invention. The system 500 includes transmitters 510, such as exemplary VCSELs having NA<0.28 and MFD of 9 um. Similar to the system 400, the transmitters 510 transmit through lenses 520 and is connected to an MCF 560 with cores having an NA of 0.30 and an MFD of 26um. According to the embodiment of system 500, the system 500 further includes launch fibers 570 and transformers 580. The transmitters 510 transmit via the launch fibers 570 having an NA of 0.20 and MFD of 37 um and the transformers 580 to TFB pigtails 540. The TFB pigtails 540 may have an NA of 0.09, MFD of 83 um, and OD of 125 um. Furthermore, the TFB pigtails 540 may be in communication with a TFB 550 having an NA>0.30 and an MFD of 26 um at its output. Thus, in contrast to the ribbon array 430 used in the system 400, the system 500 utilizes launch fibers 570 between the lenses 520 and the TFB pigtails 540. It is noted that the OD of the TFB pigtails 540 (125 um) is much greater than that of the TFB pigtails 440 (75 um) of the system 400. The splice between the TFB 550 and the MCF 560 may be a lossless splice. The lossless splice will be described in great detail below.

Both the exemplary embodiments depicted in FIGS. 4 and 5 may feature a low NA input being utilized to “filter” out the high NA light before the taper and propagated through their respective tapers. It is noted that the low NA input may add tapering loss in addition to the filtering loss. The filtered, low NA light may then be injected back into a higher NA fiber for propagation through the taper in order to have a ‘lossless’ TFB. Otherwise, such an arrangement may also have loss effects in the reverse direction.

To reduce cross-talk, light which is filtered out may be attenuated before it can couple into nearby cores. Filtering can occur at the splice or connection between fibers with a mismatch in NA or core diameter and along the taper of the TFB. Attenuation of stray light may be accomplished by methods such as bending, the inclusion of absorbing or scattering materials (e.g., either at the surface of the fiber or within portions of the glass fibers), or through the use of high index materials to strip light evanescently. According to exemplary embodiments described herein, cross-talk between the cores may be preferably less than −25 dB, and more preferably less than −30 dB and even in some cases, less than −40 dB.

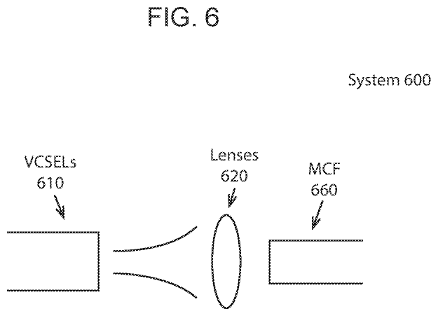

FIG. 6 illustrates an exemplary system 600 of a multicore fiber and fanout assembly in accordance with a further embodiment of the present invention. The system 600 includes transmitters 610, such as exemplary VCSELs having NA<0.28 and MFD of 9 um. Similar to the system 500, the transmitters 610 transmit through lenses 620 and is connected to an MCF 660 having an NA of 0.30 and an MFD of 26 um. However, according to the embodiment of the system 600, there is no intervening component (e.g., TFB, TFB pigtails, ribbon fiber array, launch fibers) between the lenses 620 and the MCF 660. Thus, the transmitters 610 may launch directly into the MCF 660. According to this option, the MCF may have an NA (e.g., 0.30) and MFD (e.g., 26 um) both greater than those of the exemplary transmitters 610 (e.g., 0.28 NA and 9 um MFD, respectively).

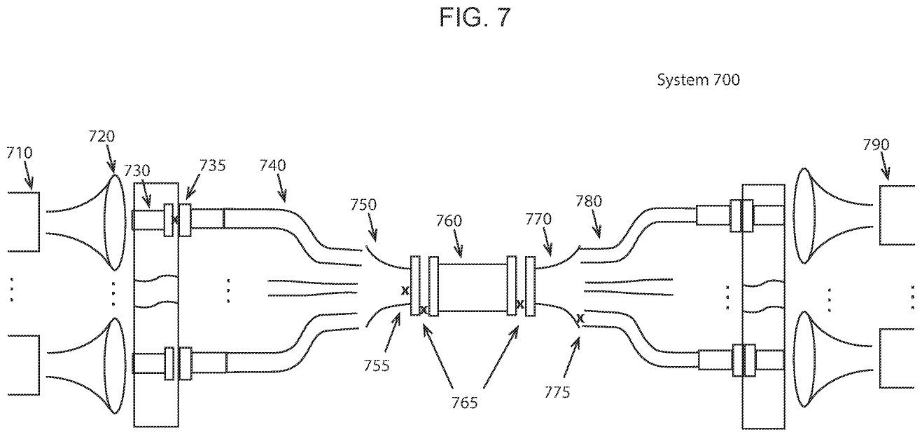

FIG. 7 illustrates an exemplary system 700 of a multicore fiber and fanout assembly in accordance with one embodiment of the present invention. Similar to the system 100, the system 700 includes transmitters 710, such as exemplary VCSELs having an NA<0.28 and an MFD of 9 um. The transmitters 710 transmit through lenses 720 and are connected to an MCF 760 with cores having an NA of 0.20 and an MFD of 26 um to a receiver 790. The transmitters 710 transmit via a ribbon array 730 comprising fibers having NA of 0.20, MFD of 50 um, and OD of 125 um. This ribbon array may be fused to TFB pigtails 740, which may be in communication with a TFB 750.

According to one embodiment, the MCF 760 may be connected to the TFB 750 via a mechanical connection at point 765. Based on the modes from the transmitters 710 filling the fibers of the ribbon array, a loss may be estimated at various points within the system 700. At point 735, the loss at the connector from the ribbon array 730 to the TFB pigtails 740 may be estimated to have a maximum loss of 2.2 dB and a nominal loss of the same value. At point 755, the taper assembly loss may be estimated to have a maximum loss of 0.8 dB and a nominal loss of 0.4 dB. At points 765, the loss at the mechanical connection between the TFB 750 and the MCF 760 for each core may be estimated to have a maximum loss of 1 dB and a nominal loss of 0.6 dB. Finally, at point 775, the taper assembly loss of the TFB 770 and the TFB pigtails 780 may be estimated to have a maximum loss of 0.8 dB and a nominal loss of 0.4 dB. Thus, the total maximum loss using the mechanical connection at point 765 may be estimated to be 2.2+0.8+1.0+1.0+0.8=5.8 dB, and the total nominal loss may be estimated to be 2.2+0.4+0.6+0.6 0.4=4.2 dB.

According to an alternative embodiment, the MCF 760 may be connected to the TFB 750 via a fusion splice at 765, as opposed to the mechanical connection described above. Accordingly, at points 765, the loss at the fusion splice between the TFB 750 and the MCF 760 of each core may be estimated to have a maximum loss of 0.5 dB and a nominal loss of 0.2 dB. Thus, the total maximum loss using the mechanical connection at point 765 may be estimated to be 2.2+0.8+0.5+0.5+0.8=4.8 dB, and the total nominal loss may be estimated to be 2.2+0.4+0.2+0.2+0.4=3.4 dB.

FIG. 8 illustrates an exemplary system 800 of a multicore fiber and fanout assembly, wherein similar options may be used for coupling both a fan-in and a fanout in accordance with one embodiment of the present invention. Specifically, the system 800 illustrates a light source (e.g., VCSEL transmitters 810) connected to a fan-in assembly 820. The exemplary cores of the fan-in assembly 820 may taper down to a smaller diameter. Accordingly, the light signals may fan into a common fiber 830. The system 800 further illustrates a receiver 850 connected to a fanout assembly 840. The exemplary cores of the fanout assembly 840 may taper up to a larger diameter. Accordingly, the light signals may fan out from the common fiber 830.

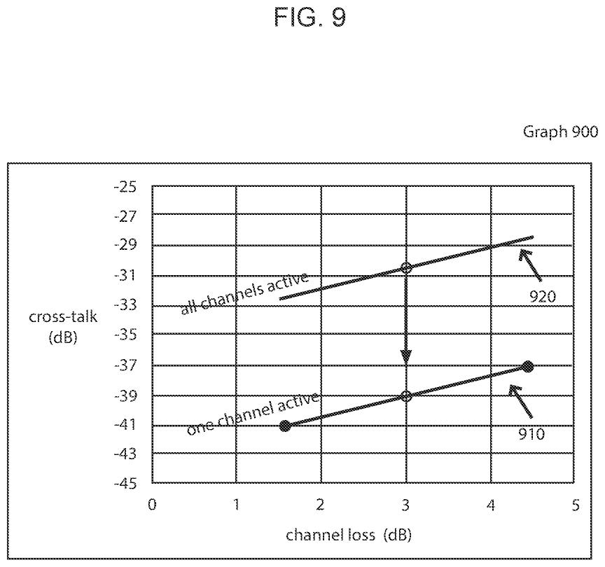

FIG. 9 illustrates an exemplary graph 900 correlating cross-talk levels and measured channel loss according to exemplary embodiments described herein. Specifically, the graph 900 demonstrates the relationship between cross-talk and the channel loss as the launch condition varies from underfilled to fully filled. For instance, two measurements (e.g., VCSEL vs. OM4) were made with only one channel active (see lower curve 910).

The upper curve 920 represents 10 G measurements with all channels lit and demonstrates a shift from the one channel curve. Thus, when an all-channel correction is taken into account, there is approximately ˜3 dB loss & −30 dB cross-talk. According to one embodiment, when the cross-talk measurement was made with one channel, the average cross-talk for one channel to another one is˜−34.4 dB. When all channels simultaneously operated, the average cross-talk is ˜−26.4 dB. The average insertion loss is ˜3.1 dB. When the 10Gb/s NRZ links transmission was tested, all channels were activated. Furthermore, the 3.1 dB insertion loss may account for the entire link (e.g., two TFB's, MCF to MCF splice and connectors, etc.).

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An optical fiber assembly for propagating a multimode (MM) signal from a light source, the optical fiber assembly comprising:
a multicore fiber (MCF) having a fiber numerical aperture (NA) value, a first core diameter and a first outer diameter (OD); and
a combiner including:
a taper fiber bundle (TFB) portion in communication with the MCF, and
at least one pigtail portion in communication with the light source;
wherein the combiner propagates the MM signal from the light source, the MM signal having a signal NA value that is less than the fiber NA value such that the MM signal underfills the at least one pigtail portion.

2. The optical fiber assembly of claim 1, wherein the fiber NA value of the MCF is greater than or equal to a TFB NA value, wherein the TFB NA value is a product of a pigtail NA value of the pigtail portion times a taper ratio of the TFB.

3. The optical fiber assembly of claim 1, wherein the signal NA value at the pigtail portion is less than an NA value of the light source.

4. The optical fiber assembly of claim 1, wherein the pigtail portion is connected to the light source via a launch fiber having an NA value greater than the signal NA value at the pigtail portion.

5. The optical fiber assembly of claim 1, wherein the launch fiber is a fiber ribbon array including either a circular ribbon configuration or a linear ribbon configuration.

6. The optical fiber assembly of claim 6, wherein the fiber ribbon array is terminated in one of a multifiber connector, a multifiber push-on connector, an expanded beam multifiber connector, and a lensed multifiber interconnect.

7. The optical fiber assembly of claim 1, wherein a loss at the TFB is less than 2.2 dB.

8. The optical fiber assembly of claim 1, wherein cross-talk between the cores is less than −13 dB.

9. The optical fiber assembly of claim 1, wherein at least one of the TFB and the TFB pigtail is configured to remove stray light through the use of a light scattering component.

10. The optical fiber assembly of claim 9, wherein the light scattering component is one of a high-index coating and a light stripping gel.

11. The optical fiber assembly of claim 1, wherein at least one of the TFB and the TFB pigtail is configured to prevent core-to-core coupling.

12. An optical fiber assembly for propagating a multimode (MM) signal from a light source, the optical fiber assembly comprising:
a multicore fiber (MCF) having a fiber numerical aperture (NA) value, a first core diameter and a first outer diameter (OD);
a combiner including:
a taper fiber bundle (TFB) portion in communication with the MCF, and
at least one pigtail portion in communication with the light source, the at least one pigtail portion having a pigtail NA value and a pigtail core diameter; and
a ribbon array in communication with the at least one pigtail portion, the ribbon array having a ribbon array NA value and a ribbon array core diameter,
wherein at least one of the ribbon array NA value and the ribbon core diameter is mismatched from the pigtail NA value and the pigtail core diameter, respectively.

13. The optical fiber assembly of claim 12, wherein the fiber NA value of the MCF is greater than or equal to a TFB NA value, wherein the TFB NA value is a product of a pigtail NA value of the pigtail portion times a taper ratio of the TFB.

14. The optical fiber assembly of claim 12, wherein the pigtail NA value is less than an NA value of the light source.

15. The optical fiber assembly of claim 12, wherein the pigtail portion is connected to the light source via a launch fiber having an NA value greater than the pigtail NA value.

16. The optical fiber assembly of claim 1, wherein cross-talk between the cores is less than −13 dB.

17. The optical fiber assembly of claim 1, wherein at least one of the TFB and the TFB pigtail is configured to remove stray light through the use of a light scattering component.

18. An optical fiber assembly for propagating a multimode (MM) signal from a light source, the optical fiber assembly comprising:
a multicore fiber (MCF) having a fiber numerical aperture (NA) value, a first core diameter and a first outer diameter (OD);
a combiner including:
a taper fiber bundle (TFB) portion in communication with the MCF, and
at least one pigtail portion in communication with the light source, the at least one pigtail portion having a pigtail NA value and a pigtail core diameter;
a transformer in communication with the at least one pigtail portion; and
a launch fiber in communication with the light source and the transformer, the launch fiber having a launch fiber NA value and a launch fiber core diameter,
wherein at least one of the launch fiber NA value and the launch fiber core diameter is mismatched from the pigtail NA value and the pigtail core diameter, respectively.

19. The optical fiber assembly of claim 18, wherein the fiber NA value of the MCF is greater than or equal to a TFB NA value, wherein the TFB NA value is a product of a pigtail NA value of the pigtail portion times a taper ratio of the TFB.

20. The optical fiber assembly of claim 18, wherein the launch fiber NA value is greater than the pigtail NA value.
